(19) United States
(12) Patent Application Publication
(10) Pub. No.: US 2013/0264128 A1
(43) Pub. Date: Oct. 10, 2013

(54) LUGGAGE LOCK

(71) Applicant: MASTER LOCK COMPANY, Oak Creek, WI (US)

(72) Inventors: Lea Marie Plato, Milwaukee, WI (US); Cris Smyczek, Greenfield, WI (US)

(73) Assignee: MASTER LOCK COMPANY, Oak Creek, WI (US)

(21) Appl. No.: 13/784,545

(22) Filed: Mar. 4, 2013

Related U.S. Application Data
(60) Provisional application No. 61/621,831, filed on Apr. 9, 2012.

(51) Int. Cl. E05B 39/00; E05B 65/52; G01G 19/52; E05B 37/00

(52) U.S. Cl. CPC E05B 39/00; E05B 37/0034; E05B 65/52; G01G 19/52
USPC 177/132; 70/21

(57) ABSTRACT

A luggage lock includes a key cylinder for use by, e.g., the transportation security administration (TSA). The luggage lock also includes a digital keypad for unlocking the lock by a primary user. The luggage lock further includes a scale for weighing luggage and a user interface element (e.g., an LED, a LCD display) for indicating the weight of the luggage determined by the scale.

### CROSS-REFERENCE TO RELATED APPLICATIONS

This applications claims the benefit of and priority to U.S. Appl. No. 61/621,831, filed Apr. 9, 2012, the entirety of which is incorporated by reference.

### BACKGROUND

The present invention relates generally to the field of luggage locks. Luggage locks are used to secure zippers, buckles, flaps, or other structures of a piece of luggage. In the United States, the Transportation Security Administration (TSA) requires access to luggage. The TSA holds “universal” or “master” keys configured to unlock TSA-approved luggage locks. Consumers do not have access to the TSA universal or master keys. Rather, consumers can access the luggage locks via a second key, combination selectors, or other methods for unlocking.

### SUMMARY

One embodiment of the invention relates to a luggage lock having both a key cylinder (e.g., TSA key cylinder) and a scale for weighing luggage. The luggage lock includes a key cylinder configured to unlock the lock via key actuation. The luggage lock further includes a scale configured to weigh luggage. The luggage lock further includes a user interface configured to report the luggage weight determined by the scale.

Another embodiment of the invention relates to a luggage lock having both a digital keypad for allowing a primary user to unlock the lock and a key cylinder (e.g., TSA key cylinder) configured to allow a secondary user (e.g., a TSA agent) to unlock the lock. The digital keypad may be configured to unlock the lock via code combination entry. The luggage lock may include a display and a circuit for the display. The circuit may be coupled to the key cylinder and configured to cause the display to indicate whether the lock was unlocked via the key cylinder.

Another embodiment of the invention relates to a luggage lock. The luggage lock includes a digital keypad configured to unlock the lock via code combination entry as well as a key cylinder configured to unlock the lock via key actuation. The luggage lock may include a display and a circuit for the display. The circuit is coupled to the key cylinder and configured to cause the display to indicate whether the lock was unlocked via the key cylinder. The key cylinder may be a transportation security administration (TSA) key cylinder configured to allow a master key held by the TSA to unlock the lock. The luggage lock may further include a scale configured to weigh luggage or other devices. The scale may include a coupling mechanism (e.g., strap, hook, loop, etc.) having one end coupled to a scale mechanism (e.g., pressure sensors, spring biased-scale element, etc.) inside the luggage lock's housing. The luggage lock may include a user interface element configured to report the luggage weight determined by the scale. The user interface may be a display. The circuit of the luggage lock may be configured to cause the display to indicate whether the lock was unlocked via the key cylinder. The user interface may also or alternatively include an audio output device. The circuit of the luggage lock may be configured to cause the display (e.g., an LED) to indicate whether the weight has exceeded a threshold. The scale can be or include a scale sensor contained within a housing of the luggage lock and a scale coupler connected to the scale sensor. In an exemplary embodiment, the scale coupler is holds a strap for coupling to the luggage being weighed. The luggage lock can include a flexible cord configured to serve as the shackle for the lock. In other embodiments, the luggage lock includes a rigid shackle. In some embodiments, the luggage lock includes a first shackle and a second shackle. The first shackle and the second shackle can both be flexible cords. The first shackle and the second shackle can be disposed at opposite distal ends of a housing of the luggage lock.

Another embodiment of the invention relates to a luggage lock. The luggage lock includes a housing and a shackle for locking or unlocking to the housing. The luggage lock further includes a key cylinder within the housing and configured to receive a key, the key cylinder configured to unlock the shackle when actuated via the key. The luggage lock further includes a primary input device coupled to the housing and separate from the key cylinder, the primary input device configured to unlock the shackle. The luggage lock yet further includes a scale coupler extending from the housing and connected to a scale sensor within the housing. The luggage lock also includes a display coupled to the housing and a circuit connected to the scale sensor and the display. The circuit is configured to cause readings from the scale sensor to be shown on the display.

Another embodiment of the invention relates to a luggage lock. The luggage lock includes a key cylinder for use by, e.g., the transportation security administration (TSA). The luggage lock also includes a digital keypad for unlocking the lock by a primary user. The luggage lock further includes a scale for weighing luggage and a user interface element (e.g., an LED, a LCD display) for indicating the weight of the luggage determined by the scale.

Another embodiment of the invention relates to a luggage lock. The luggage lock includes a shackle. The luggage lock also includes a circuit configured to evaluate user input and to determine whether to unlock a shackle in response to the user input. The luggage lock further includes a key cylinder for receiving a key that can mechanically cause the shackle to be unlocked. The luggage lock also includes an indicator that changes states when the key cylinder is used to unlock the shackle.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is an isometric view of a luggage lock, according to an exemplary embodiment;

FIG. 2 is a top view of the luggage lock of FIG. 1, according to an exemplary embodiment;

FIG. 3 is a bottom view of the luggage lock of FIG. 1, according to an exemplary embodiment;

FIG. 4 is a front view of the luggage lock of FIG. 1, according to an exemplary embodiment;

FIG. 5 is a rear view of the luggage lock of FIG. 1, according to an exemplary embodiment;

FIG. 6 is a right side view of the luggage lock of FIG. 1, according to an exemplary embodiment;

FIG. 7 is a left side view of the luggage lock of FIG. 1, according to an exemplary embodiment;

FIG. 8 is a block diagram of the luggage lock of FIG. 1, according to an exemplary embodiment; and

FIG. 9 is a flow chart of a process for operating of the luggage lock of FIG. 1, according to an exemplary embodiment.

### DETAILED DESCRIPTION

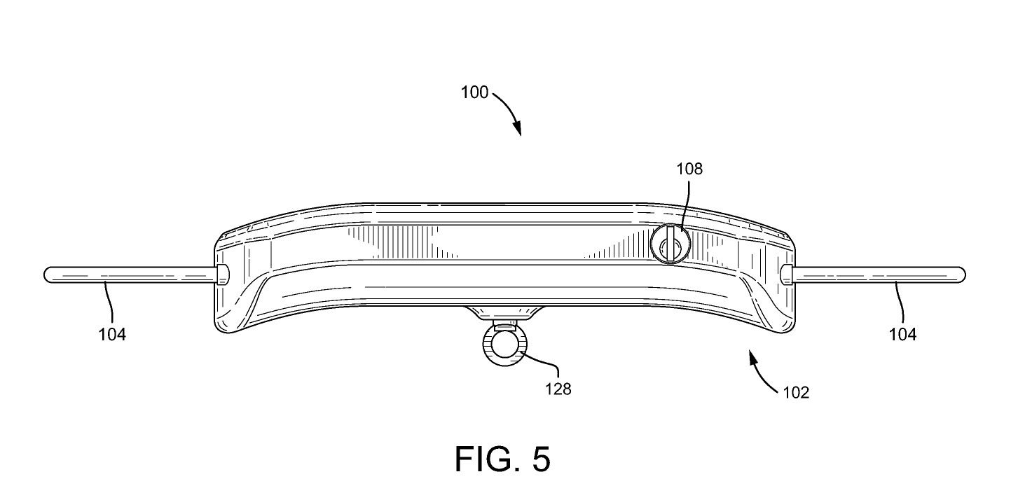

Referring generally to the FIGURES, a lock 100 is shown according to an exemplary embodiment. Lock 100 includes a housing 102 and a shackle 104 coupled to housing 102 with a locking mechanism. Lock 100 may be configured to lock a piece of luggage with a zipper closure by limiting or preventing the opening of the zipper closure. Lock 100 may be unlocked by a user using a primary input such as a digital keypad 106. Lock 100 may also be unlocked by an official such as a Transportation Security Administration (TSA) worker using a secondary input 108 (shown in FIG. 5 as a key cylinder). Secondary input 108 allows an official to open the luggage (e.g., to screen the contents of the luggage) without destroying or damaging lock 100. Lock 100 further may be utilized as a scale to allow the weight of the attached luggage to be measured. A display 110 of the luggage lock may show the determined weight and provide information about the locking activity (e.g., feedback of key presses during an unlocking procedure, feedback regarding whether the TSA lock was used, feedback regarding a status of the luggage lock, feedback regarding a battery life status, etc.).

Housing 102 is constructed of a durable (e.g., rust resistant, cut resistant, impact resistant, etc.) material that is resistant to tampering and able to withstand impacts during the handling of the luggage. According to an exemplary embodiment, housing 102 is a metal, such as aluminum or zinc. In other embodiments, housing 102 may be another metal or alloy (e.g., stainless steel, brass, aluminum alloys, plated steel, etc.) or another material, such as a high strength polymer or composite material. Housing 102 may be coated with a material such as a soft, rubberized material. Housing 102 is shown as a generally rectangular, curved or arced body with a top face 112, a bottom face 114, a front face 116, a back face 118, a left face 120, and a right face 122. Although housing 102 is shown as generally rectangular, other shapes may be provided and still fall within the scope of claims based on this disclosure. For example, the shape of housing 102 may be a cylinder (i.e., puck shape), an oval, a semi-circle, or any other shape suitable for serving as a luggage lock. In some embodiments the housing 102 has a metal core and is surrounded (partially or completely) with a plastics (e.g., impact resistant polymer) material.

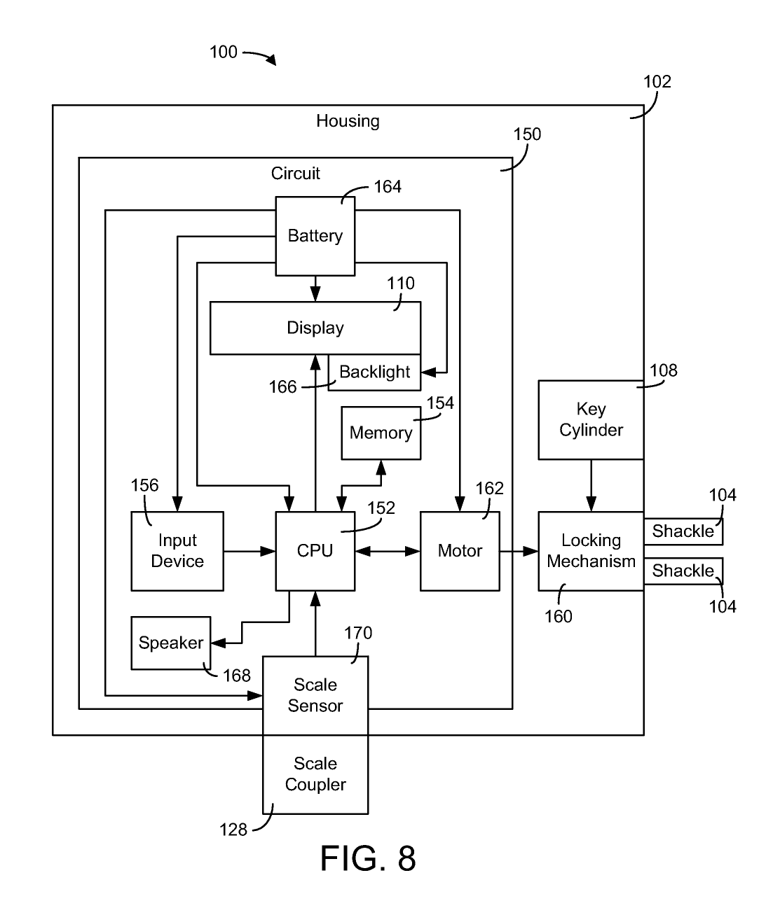

Shackles 104 are shown as coupled to left face 120 and right face 122 of housing 102. Shackles 104 may be a flexible, cable-type shackle that is configured to be passed through an opening in a moving element of the item to be secured, such as the eye of the pull tab of a zipper slider and/or around other structures of the luggage such as a clasp or luggage handle. Shackles 104 are shown as U-shaped elements with the ends of the shackles received in openings in housing 102. A locking mechanism internal to housing 102 (shown in FIG. 8 as locking mechanism 160) selectively secures (i.e., locks) the ends of shackles 104 within housing 102. According to an exemplary embodiment, shackles 104 are a braided steel cable with a polymer sleeve (e.g., jacket, coating, covering, etc.). In other embodiments, shackles 104 may be another flexible body, such as a twisted cable, or a solid polymer cable. In still other embodiments, shackles 104 may be a rigid U-shaped shackle. Shackles 104 may be a rigid partial rectangle, a bar extending between an opening in the housing, or a structure of any other suitable structure. In an exemplary embodiment, shackles 104 have a vertical shackle clearance of 1.5 inches. In other embodiments, the shackles 104 are of different lengths.

While the FIGURES show a lock with two opposing shackles coupled to the left and right sides of the housing, a variety of other configurations may be provided in varying embodiments. For example, shackles 104 may be coupled to other opposing faces of the housing, such as the top and bottom faces 112, 114 or the front and back faces 116, 118. In other embodiments, shackles 104 may be coupled to neighboring faces, such as front face 116 and right face 122. In other embodiments, the ends of shackles 104 may be coupled to different faces of housing 102. In other embodiments, lock 100 may include a single shackle 104. Moreover, shackles 104 may be different types. The shackle on one distal end of housing 102 may be of a first type (e.g., a flexible wire) while the shackle on the opposite distal end of housing 102 may be of a second type (e.g., a solid metal bar). Such a configuration may advantageously allow for a use to choose between high flexibility and high security on the same device. In embodiments where only a single shackle is included on the lock, the shackle may be a solid metal shackle. In yet other embodiments, where only a single shackle is included on the lock, the shackle is a flexible cord.

According to an exemplary embodiment, when lock 100 is coupled to luggage or another item to be secured, top face 112 of housing 102 (e.g., having the buttons and the display) is oriented outward. Luggage lock 100 includes a multitude of user interface elements disposed on top face 112 of housing 102. The user interface elements are shown to include a display 110, a keypad 106, a power switch 124, a power button 126, and auxiliary buttons (e.g., a scale reset button, a units button, etc.). The user interface allows a user to lock and unlock internal locking mechanism 160 to selectively secure shackles 104 to housing 102. In some embodiments, shackles 104 automatically lock when a user inserts the locking end of a shackle 104 and the user interface is used to unlock locking mechanism 160. In other embodiments, the locking mechanism (e.g., using an electronically controlled locking solenoid) does not engage until the user provides some further user input (e.g., a keypad press, the selection of a menu option, turns off the power switch, etc.).

According to an exemplary embodiment, the power switch and/or the power button are not included on the lock. In such embodiments, the power button 126 is a wake-up button such that the electronics of the lock “wake up” and are powered for use when the button is pressed. In an exemplary embodiment, the unit can wake when any button is pressed one or in a particular sequence (e.g., twice in a row).

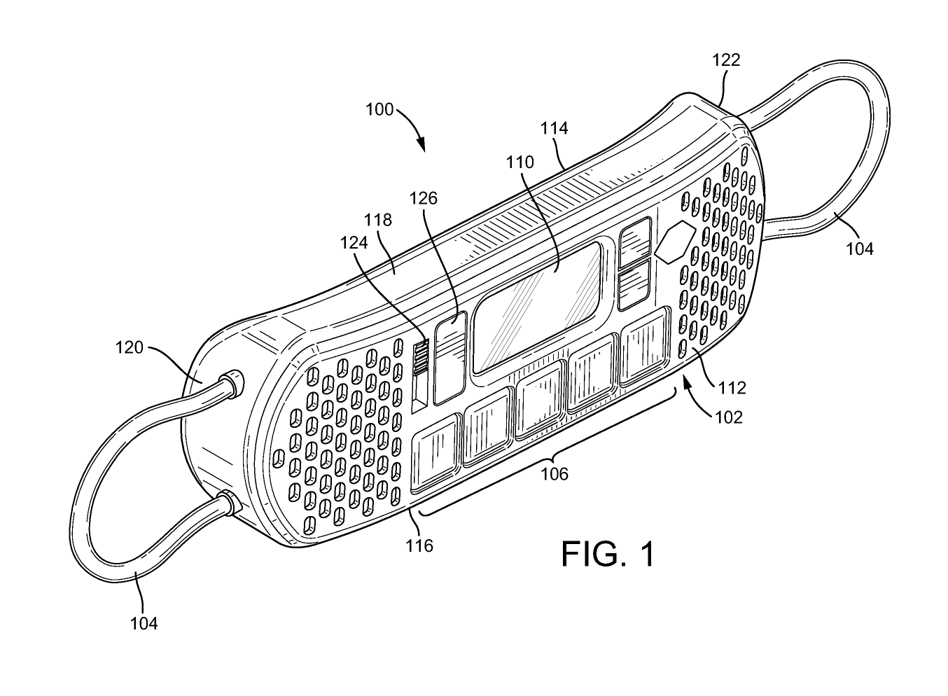

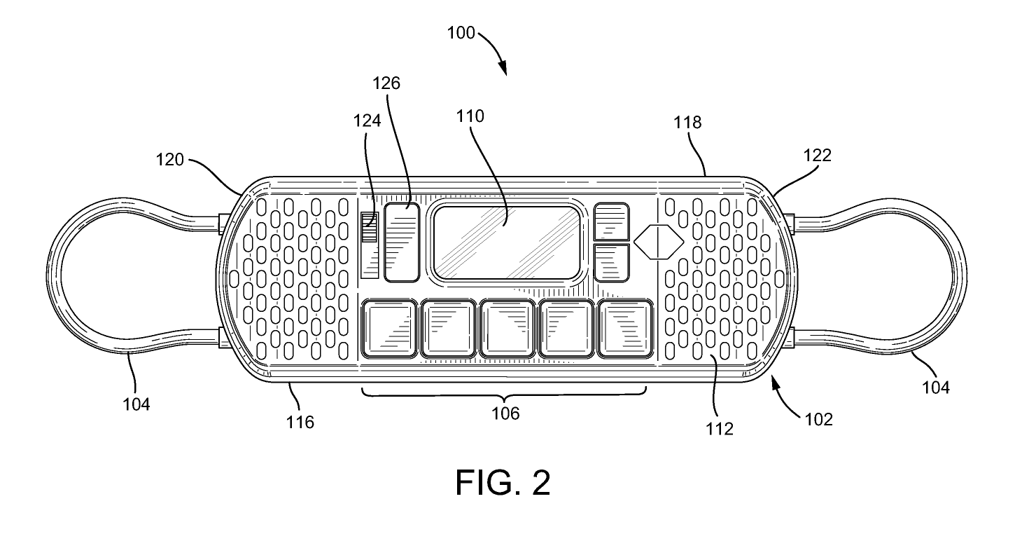

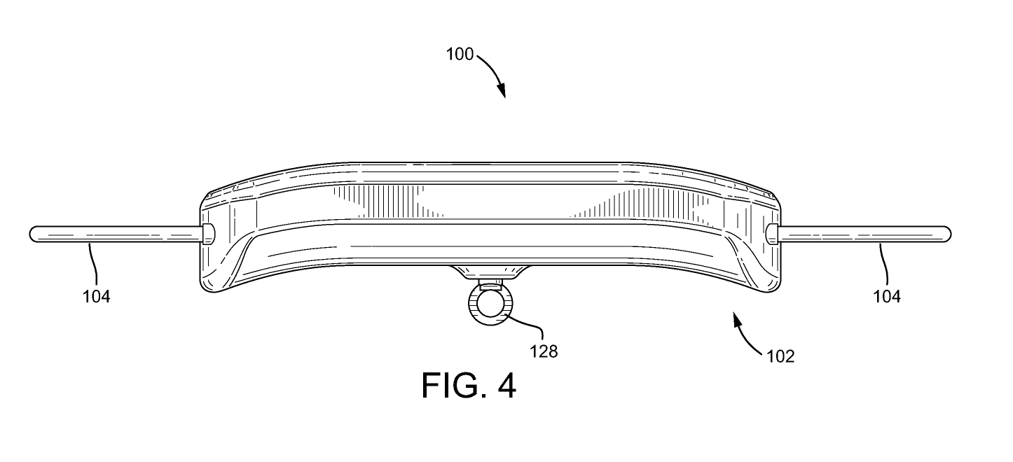

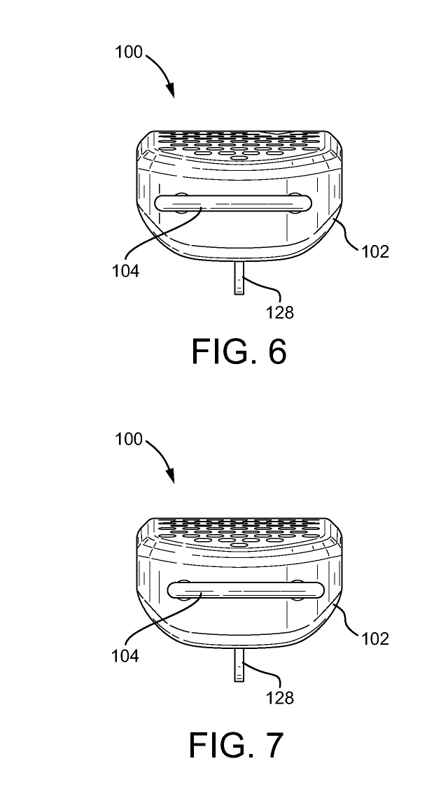

As shown in FIGS. 1-7, the top face 112 includes perforations. Such perforations may be used to provide for (e.g., assist the output of) a speaker or speakers located behind the perforations. In such embodiments the speakers are electrically coupled to a circuit of the lock and the circuit can cause audio output to be played back using the speakers. For example, the audio output may include user instructions for operating the lock (e.g., “please enter your access code”). The audio output may be or include user instructions for operating the scale feature (e.g., “please allow the scale to zero before adding weight”, “please couple the scale to weight now”). In other words, the electronic lock of FIGS. 1-7 may use pre-stored audio messages to provide for natural language audio output (e.g., instructions, commands, feedback, information, etc.).

It should be noted that the speakers can be located anywhere within the lock and that the top face of the lock can be included without the illustrated grid of perforations and can be flat, smooth, or include other designs (e.g., small raised protrusions to facilitate slip-free grip). The audio messages may be pre-stored as audio files or stored as text in memory for use by a text-to-speech converter. In one embodiment, the electronic lock includes a microphone and can receive user-recorded password reminders. Upon entry of an input sequence (e.g., with the help of a menu on a display), the playback of the recorded password reminder can be initiated.

The audio output of the electronic lock can include user alerts. Such user alerts may include, for example, alarm output indicating that a shackle cable has been cut, alarm output indicating that the lock has been forced without the entry of a valid key code, alarm output in response to three (or some other number) of invalid keypad entries, a low battery alarm, and/or other types of alarms.

Alarm output may include a proximity alarm which can be user activated via the electronics of the lock. For example, when a user knows the luggage will be left alone in a hotel room, the user may engage a proximity or accelerometer-based alarm. Electronics of the lock can cause a warning message to be played back (“please step away from the bag”) prior to causing playback of an alarm (e.g., a high-pitched alarm).

In an exemplary embodiment, one user activity (e.g., pressing a button or series of buttons) may cause certain live information calculated or determined by the electronics of the lock to be output via audio and/or the display. For example, a first user activity may cause a clock's time to be output via audio and display. A second user activity may cause the last read scale weight to be played back. A third user activity may provide the user with feedback regarding the unit's recent locking history (e.g., “the TSA lock was opened once during the last user-locking”). A fourth user activity may provide the user with a battery life indication.

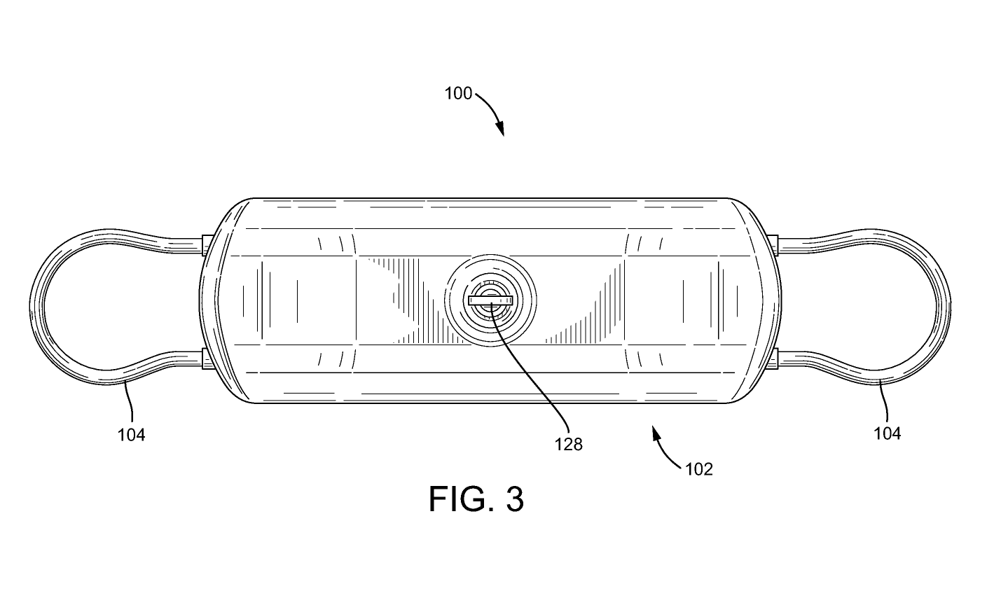

Referring still to FIGS. 1-7, the electronic lock 100 may include a user-accessible battery. While the compartment for such a battery is not illustrated in the drawings, such a battery compartment may be provided on the bottom of the housing (bottom illustrated in FIG. 3). The battery compartment may be disengaged via a sliding action, a clasp, a series of screws or any other mechanism for holding a door or panel shut but allowing user-access. In an exemplary embodiment, a battery compartment is only accessible via a slot that must be used to disengage a latch via a tool (e.g., edge of a coin, etc.). In an exemplary embodiment, the battery compartment is locked while the shackle is locked. In other words, in some embodiments the battery may only be changed when the lock is disengaged. In some embodiments, a mechanical key (e.g., inserted into the key cylinder) can be used to disengage the battery compartment. Such a key can be used in the event the battery expires while the device is locked and the keypad cannot be used to disengage the lock and/or the battery compartment (if the battery compartment locks with the primary device lock). In some embodiments the battery for the lock 100 may be rechargeable and the lock 100 may have an input (e.g., mini-USB, USB, etc.) for receiving charging voltage. In such an embodiment, even if the battery dies a charge may be used to provide enough power such that the key presses can be recognized and the lock disengaged. It should be noted that a battery life indicator can be shown on the display when the display is powered up. The battery life calculation may use age of the battery, state of charge information, or any other information (e.g., number of uses) to estimate approximate battery life.

Referring to FIG. 8, a block diagram of luggage lock 100 is shown according to an exemplary embodiment. The description to follow refers both to the particular embodiment of FIG. 8 as well as the embodiments of FIG. 1-7 and thus description made with respect to FIG. 8 can also provide detail with respect to the various embodiments of FIGS. 1-7.

Housing 102 of lock 100 is shown to include a circuit 150 coupling the electronic components of lock 100. Circuit 150 is shown to include a central processing unit (CPU) 152 and memory 154. CPU 152 may be implemented as a general purpose processor, an application specific integrated circuit (ASIC), one or more field programmable gate arrays (FPGAs), a group of processing components, or other suitable electronic processing components. Memory 154 is one or more devices (e.g., RAM, ROM, Flash memory, hard disk storage, etc.) for storing data and/or computer code for completing and/or facilitating the various processes described herein. Memory 154 may be or include non-transient volatile memory or non-volatile memory. Memory 154 may be integrated with the CPU or separate from the CPU (as shown). Memory 154 may include database components, object code components, script components, or any other type of information structure for supporting the various activities and information structures described herein. Memory 154 is shown as communicably connected to CPU 154 and may include computer code or instructions for executing one or more processes described herein.

It should be appreciated that circuit 150 may be or include one or more PCBs containing an integrated circuit or circuits for completing the activities described herein. The CPU may be one or more integrated circuits having firmware for causing the circuitry to complete the activities described herein.

The user provides an input or unlock code with an input device 154 such as keypad 106 shown in FIGS. 1-7. In one embodiment, keypad 106 may include five keys spaced in a row below the display. In varying embodiments, fewer or more keys may be provided. The keys may be a rigid material or may be a soft, rubberized material. The keys may each include single or multiple number and letter labels, allowing a user to memorize an entry code as a multi-digit number, a word, or a combination of letters and numbers. Circuit 150 may be configured to allow the user to set his or her own unlock code. A key combination may be recognized by the circuit 150 for placing the lock 100 into a mode of operation for changing the key code. The process of receiving and storing a new key code can be driven by the circuit using the display and/or audio output. For example, once the circuit 150 places the lock into the mode of operation for changing the key code, the circuit 150 can present display and/or audio prompts and instructions for changing the code.

In some embodiments only the correct entry of the code (e.g., 3 digits, 4 digits, more than 4 digits, a user-programmable number of digits) results in the unlocking of one or both shackles 104. In other embodiments, the user may be required to enter an unlock code with another input device, such as dial(s), biometric devices (e.g., fingerprint scanner), or any other type of input device that can be used to provide an unlock code to lock 100. Such additional input devices may be provided on housing 102 in varying embodiments of luggage lock 100.

The data from input device 156 is provided to the processor (CPU 152). Processor 152 may determine whether a correct unlock code was provided through input device 156 by comparison of the unlock code with a code stored in memory 154 accessible by processor 156. If a correct unlock code is provided, processor 152 signals an actuator such as a motor 162 to unlock locking mechanism 160 that mechanically unlocks/locks shackles 104 of lock 100. In one exemplary embodiment, locking mechanism 160 may include a solenoid coupled to a bar or other blocking mechanism configured to prevent the end of a shackle 104 from being withdrawn from housing 102 until a valid code has been provided via input device 156. Further, the user may use input device 156 to reset or change the unlock code.

Processor 152 may determine if a user input via input device 156 indicates a desire to reset or change the unlock code. For example, to initiate a code change, the user may hold one or more buttons on keypad 106 for a set period of time, the user may input a special code, or the user may conduct a different activity detectable by CPU 152 as requesting a code change. In an exemplary embodiment, the code can only be changed when luggage lock 100 is unlocked. Once circuit 150 recognizes a change code request, the user may then input a new unlock code and processor 152 may store the code in memory 154.

An on-board power source (e.g., a battery 164) is provided for electronic components of lock 100, such as CPU 152, display 110, input device 156, and motor 162. Battery 164 may be a thin coin cell (or cells) or a AAA cell battery. Other battery types may also be provided in varying embodiments. To reduce power requirements and form factor, CPU 152 may be a low-power processor and battery 164 may be chosen to reduce the size of the internal components of lock 100. This may in turn help to reduce the size of housing 102 and overall size of lock 100. The battery life may be monitored and conveyed to the user with an indicator, such as a scale or low battery warning. The battery life indicator may be shown on display 110 or may be a separate indicator, such as an LED or multiple LEDs.

According to an exemplary embodiment, the power source is a battery housed in a battery compartment in housing 102. The battery compartment may be a drawer-type compartment that can only be accessed when lock 100 is unlocked. The battery compartment may include a battery jump slot for emergency access. Luggage lock 100 may be configured such that removing battery 164 does not allow lock 100 to be opened by keypad 106 or other user input 156. In such a configuration, only when luggage lock 100 is powered and the code is entered, does motor 162 engage to unlock locking mechanism 160.

Power from battery 164 to the electronic components of lock 100 may be controlled with power button 126 and power switch 124. In an exemplary embodiment, power button 126 may be utilized to activate or wake up components such as keypad 106 and display 110 from a sleep state. In some embodiments, power button 126 or other buttons of luggage lock 100 may have multiple functions. For example, after an initial power-up or activation, power button 126 may subsequently be used as an enter button to provide a code entered with keypad 106 to CPU 152 to be checked against a stored code. If the provided code matches the stored code, keypad 106 may return to a sleep state, either upon a successful unlocking of locking mechanism 160 or after a predetermined time period.

Power switch 124 may be provided to prevent wasteful battery drain due to inadvertent pressing of power button 126 or keypad 106, such as by luggage handlers or contact with other luggage. In an exemplary embodiment, power switch 124 is a slide switch that is recessed in housing 102. Power switch 124 is moved to an on position when the user wishes to unlock locking mechanism 160 or otherwise utilize the powered features of lock 100 (e.g., utilizing the user interface, utilizing the scale).

In some countries, baggage security screening may require luggage to be opened for a physical inspection or screening. A secondary, override input in the form of a key cylinder 108 is provided to allow an official with an appropriate tool (e.g., universal key, master key, TSA key, etc.) to open lock 100 without knowing the digital input code and without damaging or destroying lock 100. Key cylinder 108 is able to open locking mechanism 160 independent of motor 162 (or other powered or processing circuit activity) to release shackles 104 from locking mechanism 160 and housing 102. In some embodiments, key cylinder 108 supports multiple keys. For example, a first particular key may be retained by the user for regular access to luggage lock 100 while a second ‘master’ or ‘universal’ key may be retained by the TSA for opening luggage lock 100 during luggage screening procedures. In certain embodiments, key cylinder 108 is not provided on luggage lock 100 and another input secondary input device is provided in its place. For example, in some embodiments the TSA input is an electrical or wireless input configured to cause circuit 150 to detect one or more signals/codes and to cause locking mechanism 160 to unlock. In some embodiments, for example, the TSA input is a long code unknown by the owners of the lock. In other embodiments, the TSA input and the user input are both via key and there are two key cylinders rather than a key cylinder and a key pad.

Lock 100 may also be utilized as a scale to measure the weight of an object suspended from lock 100, such as a piece of luggage. Lock 100 includes a scale coupler 128 (e.g., hook, eye, ring, bracket, etc.) from which an object to be weighed (e.g., the luggage) may be coupled. According to an exemplary embodiment, scale coupler 128 is a ring-shaped member provided on bottom face 114 of housing 102. An adjustable strap may be provided to facilitate the attachment of an object to scale coupler 128. For example, an adjustable strap may be connected to scale coupler 128 and then subsequently strapped to the luggage to be weighed. When lock 100 is not being used to weigh an object, the strap may be used to secure lock 100 to luggage or another object. In an exemplary embodiment, different types of scale couplers interchangeable via a screw-in engagement or another engagement.

In the FIGURES, scale coupler 128 is shown on bottom face 114 of luggage lock 100. As shown in the FIGURES, housing 102 of luggage lock 100 is formed such that the distal ends are curved, providing a somewhat concave shape to bottom face 114. This concave formation may provide the user with a surface for gripping when weighing heavy luggage. For example, the user could wrap his or her fingers around the distal ends of luggage lock 100, with the user's fingers located on bottom face 114 of housing 102. The concave nature may help the user maintain a grip on housing 102. In varying embodiments, housing 102 may be shaped differently. For example, finger depressions may be provided to further facilitate the holding of housing 102 for the purpose of weighing luggage. In an exemplary embodiment, portions of housing 102 may have an anti-friction surface or coating to prevent slipping of grip while the luggage is being weighed.

In varying embodiments, scale coupler 128 is not provided on bottom face 114 of housing 102 but is instead provided on an end of housing 102, on the side of housing 102, and/or on the front of housing 102. In an exemplary embodiment, a load cell is embedded in housing 102 such that the shackle itself can be used as scale coupler 128 for weighing the luggage.

In FIG. 8, scale coupler 128 is shown as coupled to housing 102 through scale sensor 170, such as a load cell or strain gauge. The object to be weighed is attached to scale coupler 128 and suspended below lock 100 by grasping housing 102 and lifting lock 100 until the object to be weighed is pulled off the ground. The weight of the object is then determined by CPU 152 using the input from scale sensor 170. For example, if sensor 170 is a load cell sensor, the weight of the object slightly deforms the load cell, causing a change in resistance to an electric current passing through the load cell, which is detected by CPU 152. Lock 100 may be lifted with one hand or may be lifted with two hands to weigh a heavier object. According to an exemplary embodiment, scale sensor 170 has a capacity of approximately 100 pounds or 45 kilograms. In other embodiments, other capacities may be provided.

The weight is output to the user via display 110. According to an exemplary embodiment, display 110 is a backlit LCD display including a backlight 166 provided on top face 112 of housing 102 to be easily viewable by the user. Display 110 may be configured to show the weight of the object in different unit systems (e.g., imperial, metric, etc.). The units for the weight displayed may be changed utilizing the unit button. A reset button may be provided to allow the user to zero or calibrate the scale. In some embodiments, the backlit LCD (e.g., backlight 166) is not provided. In such embodiments, a series of LEDs or other user interface output devices may be used to communicate status and/or other information to a user. In yet further embodiments, LEDs or other user output devices are used in conjunction with the backlit LCD display 110. While the LCD display is described as backlit in the Figures, in varying embodiments the LCD display is not a backlit LCD display. While LCD is one technology that could be used to provide the display, other technologies (OLED) may also or alternatively be used to provide the display. In an embodiment where a series of LEDs are provided for communicating the weight of luggage to a user, one or more LEDs may be configured to illuminate when the luggage exceeds certain thresholds. For example, because 50 lbs is a popular threshold associated with additional charges by airlines, an LED may blink red when the luggage is sensed to exceed 50 lbs. A second LED may blink red when the luggage is sensed to exceed 75 lbs. Two LEDs may be held solid red when the bag exceeds 100 lbs. Other lighting schemes involving varying numbers of LEDs, colors, and/or solid/blinking activity may be used to communicate weight of luggage to a user.

According to an exemplary embodiment, the lock 100 can be calibrated using a known weight and the keypad with the display. A key press combination or menu item may be selected to facilitate, start, adjust, or end the calibration process.

According to various exemplary embodiments, the lock may further include other input or output interfaces. For example, the lock may include a speaker 168 or other audio device that is coupled to CPU 152 and receives an audio output to provide to the user of lock 100. As another example, lock 100 may include other types of input devices 156 (e.g., touchscreen, dial, microphone, scanner, etc.) that allow a user to input an unlock code or to otherwise operate lock 100.

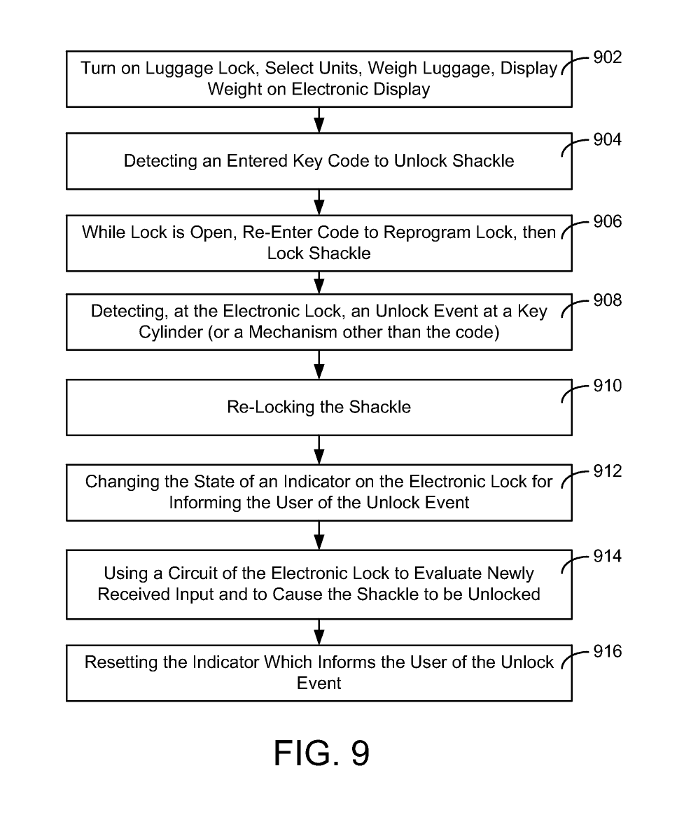

Referring now to FIG. 9, a flow chart of a process for operating the luggage lock 100 described with respect to previous Figures is shown, according to an exemplary embodiment. The process includes the step(s) of turning on the luggage lock (e.g., via an input device 156, a keypad, a power switch and/or button, etc.), selecting units (e.g., via a units button, via a menu option, etc.), weighing luggage (e.g., using the scale coupler 128 and scale sensor 170), and displaying the weight on the electronic display 110. (Step 902). When the luggage lock is in a mode for weighing luggage, the process may include some amount of feedback (e.g., via speaker 168, via the display 110) caused to be output by the circuit 150. The feedback may include instructions for zeroing the scale, instructions for waiting until start-up steps are complete.

The process of FIG. 9 further includes detecting and entered a key code to unlock the shackle. (Step 904). In some embodiments the circuit 150 may be ready for receiving and evaluating an entered key code at any time. In other embodiments the circuit 150 must be placed into a mode of operation (e.g., accessible via a menu, switched to by holding an “unlock” button, etc.). If incorrect codes are entered, the circuit 150 may cause the playback of a hint or display of a hint for recovering the correct code. In some embodiments, if an incorrect code is entered too many times (e.g., 3, 5, 7, etc.) the circuit 150 will not evaluate any further codes for a period of time (e.g., to deter further attempts or theft). If an incorrect code is entered too many times (or even once), the circuit 150 may cause a failed key code entry message to be displayed until the lock is successfully cleared. This message (e.g., or LED light, audible alert, etc.) may be shown to the user upon next power-up or shown to the user once an authorized code is received and the lock is disengaged.

In step 906, while the lock is open, a new or the same code can be entered or re-entered to reprogram the lock, then the shackle can be engaged and the device can lock. Other code reprogramming procedures may alternatively be used. For example, in some embodiments the circuit includes a menu option for reprogramming a code.

At step 908, once the lock has been locked for some time, the circuit can detect an unlock event at the key cylinder (or some other secondary unlocking mechanism). This step can be an unlock associated with a third party (e.g., TSA personnel). This unlock event can be triggered by some mechanism other than the primary code setup by the user. In various embodiments, therefore, this unlock event can be a master key code, an RFID trigger (the circuit may include an RFID antenna for receiving and/or responding to RFID communications), an NFC trigger, a key in a TSA cylinder, etc.). The lock can be relocked (e.g., by the TSA) in step 910. In response to detecting the unlock event of step 908, the circuit can cause the state of an indicator (e.g., LED, display element on display 110) to be displayed to the user, for informing the user about the unlock event (step 912).

At step 914, at some later time, the circuit of the electronic lock can evaluate newly received input (e.g., received via the user interface) and can cause the shackle to be unlocked. This unlock can be made via the code programmed in step 906 by the user. Once the user enters the correct code, information about the TSA unlock event can be shown to the user. For example, the user can see the time of the unlock event, how long the lock was unlocked by the TSA, how many times the lock was unlocked by the TSA, a unique identifier associated with the key used, or other information that can be recorded by the circuit 150 when the key cylinder 108 (or another secondary unlock mechanism) is used rather than the primary key code. Once the user is satisfied, the user can reset or otherwise clear the indicator which informs the user of the TSA unlock event.

It should be noted that while the TSA is noted in this disclosure, the primary/secondary unlock capabilities and tracking of the disclosed lock may be used in other applications. For example, a child may be able to use such a lock on a school locker (e.g., so that the child and/or the child's parents can know when the school has access the child's locker contents).

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media (e.g., tangible and/or non-transitory) for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, flash memory, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The construction and arrangement of the luggage lock and scale as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

1. A luggage lock comprising:
a key cylinder configured to unlock the lock via key actuation;
a scale configured to weigh luggage; and
a user interface configured to report the luggage weight determined by the scale.

2. The luggage lock of claim 1, further comprising:
a keypad configured to allow the entry of a key combination for unlocking the lock.

3. A luggage lock comprising:
a digital keypad configured to unlock the lock via code combination entry; and
a key cylinder configured to unlock the lock via key actuation.

4. The luggage lock of claim 3, further comprising:
a display and a circuit for the display, wherein the circuit is coupled to the key cylinder and configured to cause the display to indicate whether the lock was unlocked via the key cylinder.

5. The luggage lock of claim 3, wherein the key cylinder is a transportation security administration (TSA) key cylinder configured to allow a master key held by the TSA to unlock the lock.

6. The luggage lock of claim 5, wherein the luggage lock further comprises:
a scale configured to weigh luggage; and
a user interface element configured to report the luggage weight determined by the scale.

7. The luggage lock of claim 6, wherein the user interface element is a display.

8. The luggage lock of claim 6, wherein the user interface element is the display used to indicate whether the lock was unlocked via the key cylinder.

9. The luggage lock of claim 6, wherein the user interface is an audio output device.

10. The luggage lock of claim 6, wherein the user interface is at least one LED configured to communicate whether the weight has exceeded a threshold.

11. The luggage lock of claim 6, wherein the scale comprises a scale sensor contained within a housing of the luggage lock and a scale coupler connected to the scale sensor, wherein the scale coupler is configured to hold a strap for coupling to the luggage being weighed.

12. The luggage lock of claim 6, further comprising:
a flexible cord configured to serve as the shackle for the lock.

13. The luggage lock of claim 6, further comprising:
a rigid shackle.

14. The luggage lock of claim 6, further comprising:
a first shackle; and
a second shackle.

15. The luggage lock of claim 14, wherein the first shackle and the second shackle are flexible cords.

16. The luggage lock of claim 14, wherein the first shackle and the second shackle are disposed at opposite distal ends of a housing of the luggage lock.

17. A luggage lock, comprising:
a housing;
a shackle for locking or unlocking to the housing;
a key cylinder within the housing and configured to receive a key, the key cylinder configured to unlock the shackle when actuated via the key;
a primary input device coupled to the housing and separate from the key cylinder, the primary input device configured to unlock the shackle;
a scale coupler extending from the housing and connected to a scale sensor within the housing;
a display coupled to the housing; and
a circuit connected to the scale sensor and the display, wherein the circuit is configured to cause readings from the scale sensor to be shown on the display.

18. The luggage lock of claim 17, further comprising a second shackle, wherein the housing is elongated along a primary axis and wherein the first shackle and the second shackle are disposed at distal ends of the housing.

19. The luggage lock of claim 17, wherein the key cylinder is a transportation security administration (TSA) key cylinder.

20. The luggage lock of claim 17, wherein the circuit uses the display to:
(a) indicate whether the key cylinder was used to unlock the lock;
(b) to indicate the status of the primary input device; and
(c) cause readings from the scale sensor to be shown on the display.

21. The luggage lock of claim 17, further comprising:
a battery coupled to the circuit for powering the circuit and a motor for actuating the locking mechanism of the luggage lock.

22. A method, comprising:
locking a shackle at an electronic lock;
detecting, at the electronic lock, an unlock event at a key cylinder;
relocking the shackle at the electronic lock;
changing a state of an indicator on the electronic lock for informing a user of the unlock event;
using a circuit of the electronic lock to evaluate input received via a user interface device and to cause the shackle to be unlocked; and
resetting the indicator which informs the user of the unlock event.

23. The method of claim 22, further comprising:
recording information regarding the unlock event and storing the information in memory coupled to the circuit; and
displaying the recorded information via an electronic display coupled to the circuit.

24. The method of claim 23, wherein the information comprises at least one of:
a) a time of entry;
b) a duration of entry;
c) the number of separate entries; and
d) a unique identifier associated with the key used.
